(19) United States
(12) Patent Application Publication
(10) Pub. No.: US 2008/0316756 A1
(43) Pub. Date: Dec. 25, 2008

(54) LAMP

(76) Inventor: Tsun-Mu WU, Hemei Township (TW)

Correspondence Address: EGBERT LAW OFFICES, 412 MAIN STREET, 7TH FLOOR, HOUSTON, TX, 77002, US

(21) Appl. No.: 11/767,504

(22) Filed: Jun. 23, 2007

(51) Int. Cl. F21V 21/00

(52) U.S. Cl. 362/382

(57) ABSTRACT

The present invention provides a lamp structure that overcomes the shortcomings of a typical lamp with a fixed radiation angle and single support or main pedestal. The lamp includes a main pedestal and a support. The main pedestal has an assembly portion. A positioning member is used to control the positioning or released state of the assembly portion, so that the support could be adjusted to allow for flexible rotation of the radiation angle of the light-emitting body if the flexible locking bead and locating hole are positioned securely. The support could be removed from or assembled into different types of main pedestals through the recessed pattern of holes set on the main pedestal. Thus, a single support could be applied to a variety of main pedestals for improved application of lamps.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a lamp, and more particularly to an innovative lamp with a combined structure.

2. Description of Related Art Including Information Disclosed Under 37 CFR 1.97 and 37 CFR 1.98

Lamps are now an integral part of household appliances for the general public, who pay much attention to aesthetic and artistic feelings. So, customized lamps are designed to meet market demands. For a typical lamp, such as a hanging lamp or a wall lamp, the main pedestal is connected to a support, one end of which is provided with light-emitting bodies to form a light-emitting structure.

However, the following shortcomings are found in actual application.

1. For a typical hanging lamp or free-standing lamp structure, the support is often connected to the main pedestal at a fixed direction, so the lighting angle of the light-emitting body cannot be adjusted randomly.

2. If a single type of support is manufactured, only a single main pedestal is connected, so the manufacturing method is constrained by production efficiency.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

The lamp A comprises a main pedestal 10 and at least a support 20. The main pedestal 10 has an assembly portion 11, and the support 20 is provided with a connecting end 21 corresponding to the main pedestal 10, and a protruding end 22 for assembly of light-emitting body 30. Moreover, the support 20 is electrically connected to the main pedestal 10. The connecting end 21 of said support 20 is coupled with the main pedestal 10, which is combined with the support 20. The mounting portion 24 and coupling portion 23 could be fitted with an electrical connector 50 that can be engaged or separated. While the flexible locking bead 26 and locating hole 25 could be positioned securely, the support 20 could be adjusted to allow for flexible rotation of the radiation angle of the light-emitting body 30.

The main pedestal 10 is coupled with the support 20, and a positioning member 40 is used to control the positioning or release state of the mounting portion 24 and coupling portion 23. The support could be removed from or assembled into different types of main pedestals 10 through the recessed pattern of holes set on the main pedestal 10. Thus, a single support could be applied to a variety of main pedestals 10 for improved application of lamp A.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the present invention.

FIG. 2 shows a partial sectional view of the present invention.

FIG. 3 shows a top view of the present invention.

FIG. 4 shows a sectional view of the present invention.

FIG. 5 shows an assembled sectional view of the operation of the present invention.

FIG. 6 shows a partially exploded sectional view of the present invention.

FIG. 7 shows a lateral schematic view of the present invention.

FIG. 8 shows another schematic view of the present invention.

FIG. 9 shows another schematic view of application of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

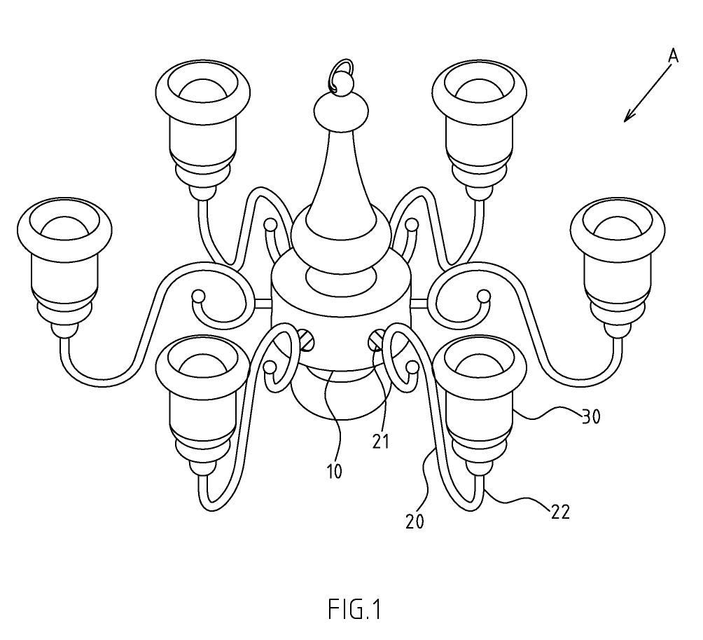

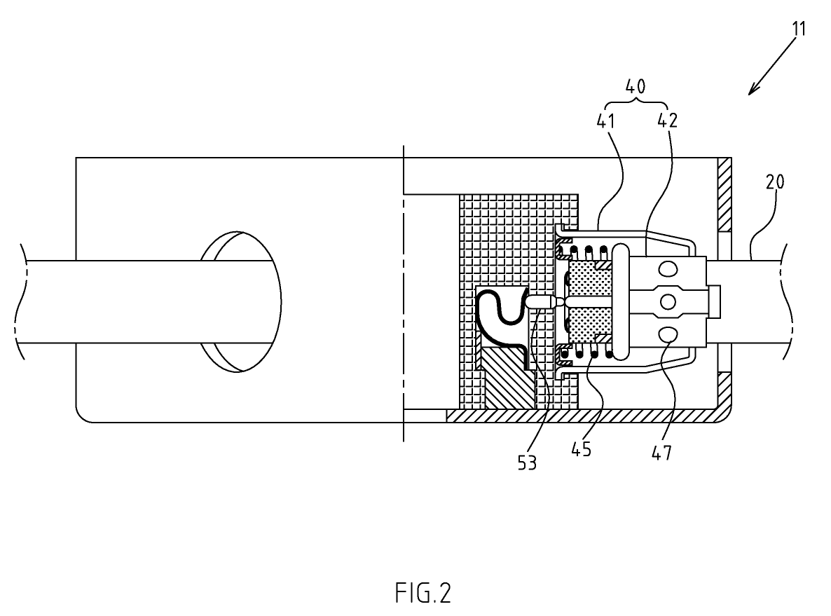

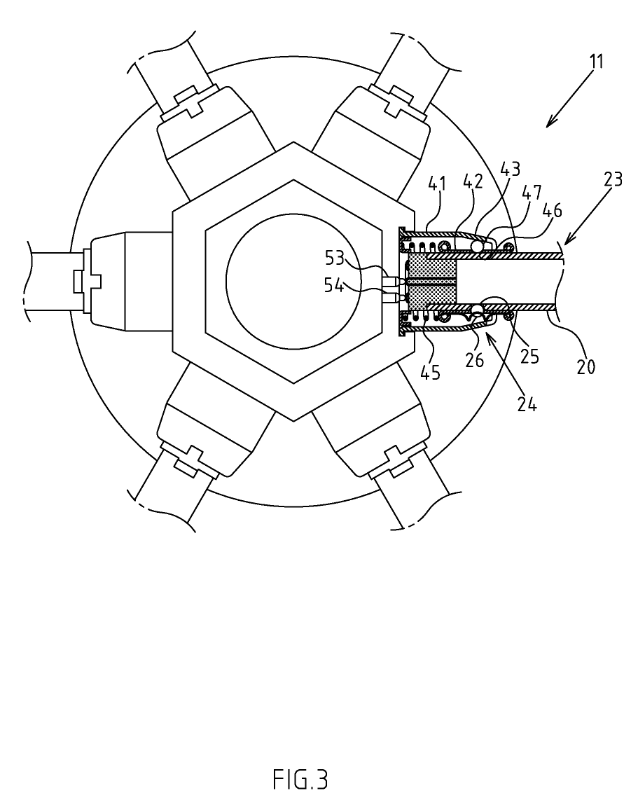

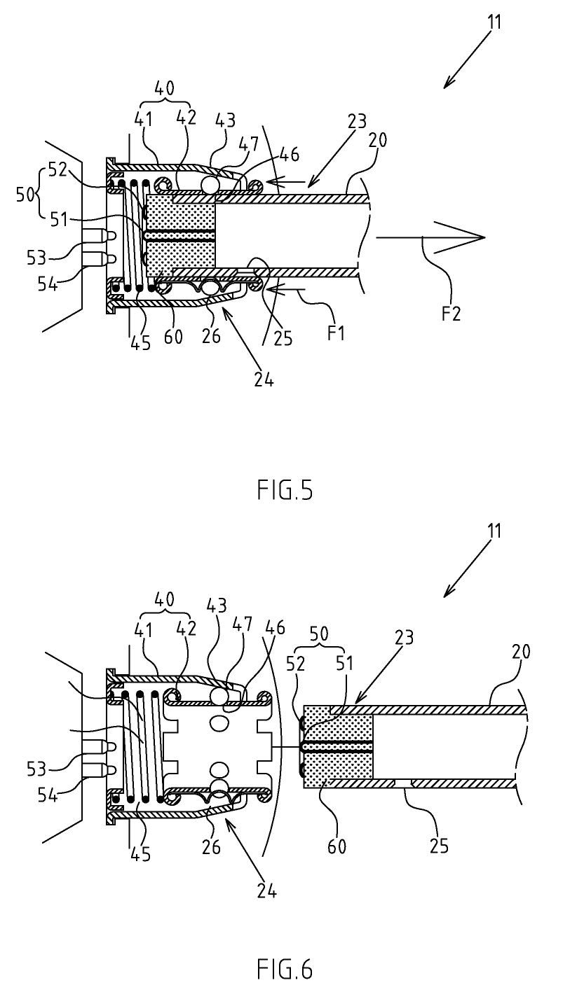

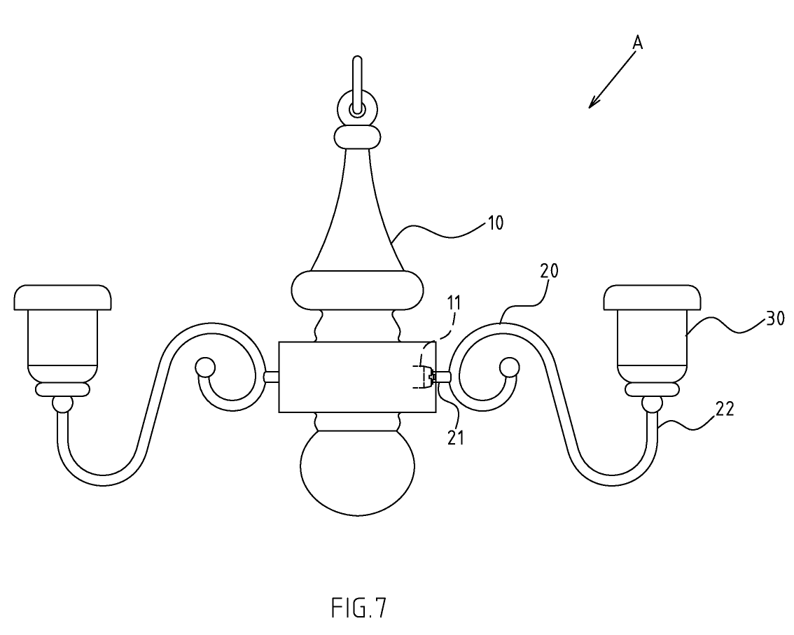

FIGS. 1-9 depict preferred embodiments of the combined lamp structure of the present invention. The embodiments are provided only for explanatory purposes. The lamp A comprises a main pedestal 10 and at least a support 20. The main pedestal 10 has an assembly portion 11, which is either a hanger or a free-standing rack. The support 20 is provided with a connecting end 21 corresponding to the main pedestal 10, and a protruding end 22 for assembly of light-emitting body 30. Moreover, the support 20 is electrically connected to the main pedestal 10.

The connecting end 21 of said support 20 is coupled with the main pedestal 10, and also provided with a coupling portion 23. The main pedestal 10 is provided with mounting portion 24 for the coupling portion 23, while a positioning member 40 is used to control the positioning or release state of the mounting portion 24 and coupling portion 23.

The positioning member 40 contains an external cylinder 41 and an internal cylinder 42, of which an inclined guide surface 43 is fitted externally onto the external cylinder 41. The internal cylinder 42 is supported by an elastic member 45, while a through-hole 46 on the preset location of internal cylinder 42 corresponds to the coupling portion 23 at the connecting end 21 of the support 20. Moreover, a positioning bead 47 is placed between the through-hole 46 and inclined guide surface 43 of the external cylinder 41, so that the positioning bead 47 is pressed tightly onto the coupling portion 23 of the connecting end 21 of the support 20, and released by the internal cylinder 42. Furthermore, the mounting portion 24 and coupling portion 23 could be fitted with an electrical connector 50 that can be engaged or separated.

The electrical connector 50 comprises a central conducting bar 51 and a circular conducting strip 52 on one end of the coupling portion 23. The central conducting bar 51 is separated from the circular conducting strip 52 via an insulator 60, thus avoiding the contact of positive and negative electrodes generated from the contact of central conducting bar 51 and circular conducting strip 52. A central conducting terminal 53 and an eccentric conducting terminal 54 are placed at intervals opposite to the mounting portion 24. The central conducting terminal 53 contacts the central conducting bar 51 of the coupling portion 23, while the eccentric conducting terminal 54 contacts the circular conducting strip 52 of the coupling portion 23.

Based upon above-specified structures, the present invention is operated as follows:

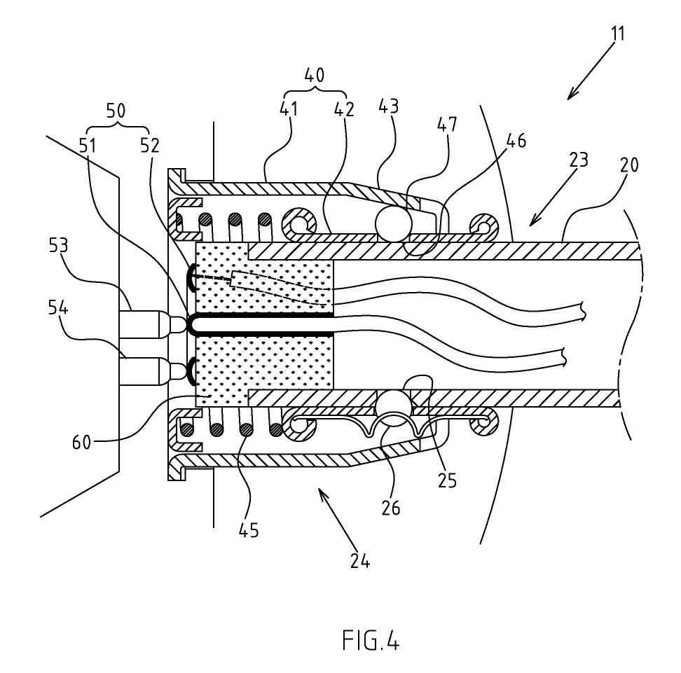

Referring to FIGS. 4, 5, and 6, the coupling portion 23 and mounting portion 24 form a recessed pattern of holes. When the locating hole 25 of the coupling portion 23 is locked with the flexible locking bead 26 of the mounting portion 24, the through-hole 46 and positioning bead 47 are positioned securely. Since the coupling portion 23 is supported by the elastic member 45, the positioning bead 47 being pushed is tightly coupled with the inclined guide surface 43 when a lateral force F2 is applied to the coupling portion 23. The central conducting terminal 53 and eccentric conducting terminal 54 are electrically contacted with the electrical connector 50, thus energizing the light-emitting body 30. If it is intended to remove the support 20, a lateral force F1 is applied to the internal cylinder 42 for internal pushing, so the positioning bead 47 locked with through-hole 46 will be disengaged gradually. In such case, a lateral force F2 is applied to separate the support 20 from the main pedestal 10.

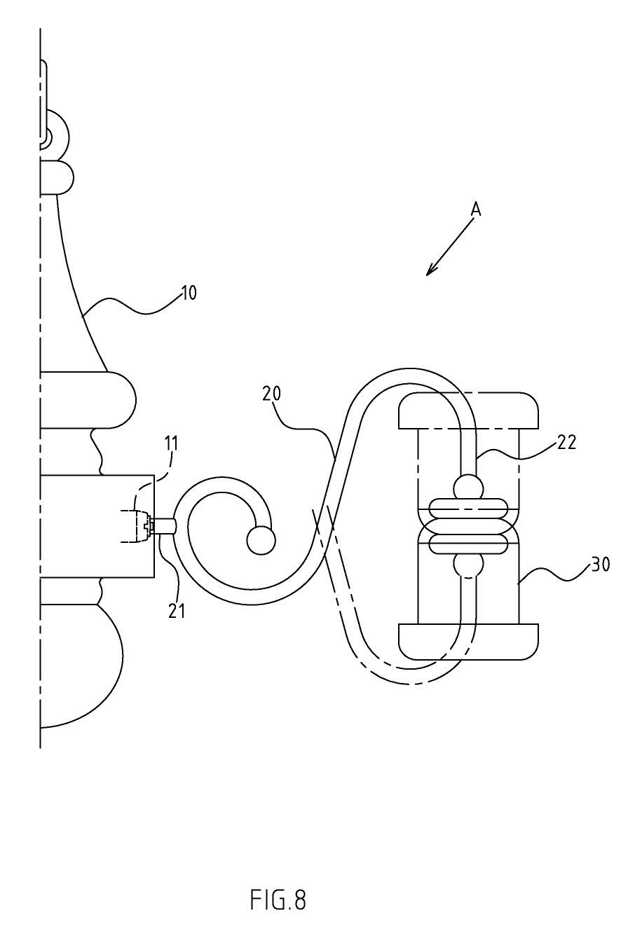

The flexible locking beads 26 of the coupling portion 23 could be arranged at intervals, so that said bar-like coupling portion 23 could rotate at a preset angle (e.g. 180 degrees) for locking with said locating hole 25. Said circular conducting strip 52 and eccentric conducting terminal 54 form a circular conducting pattern, so that said support 20 could rotate at 180 degree, enabling another radiation angle of the light source of the light-emitting body 30 (shown in FIG. 8).

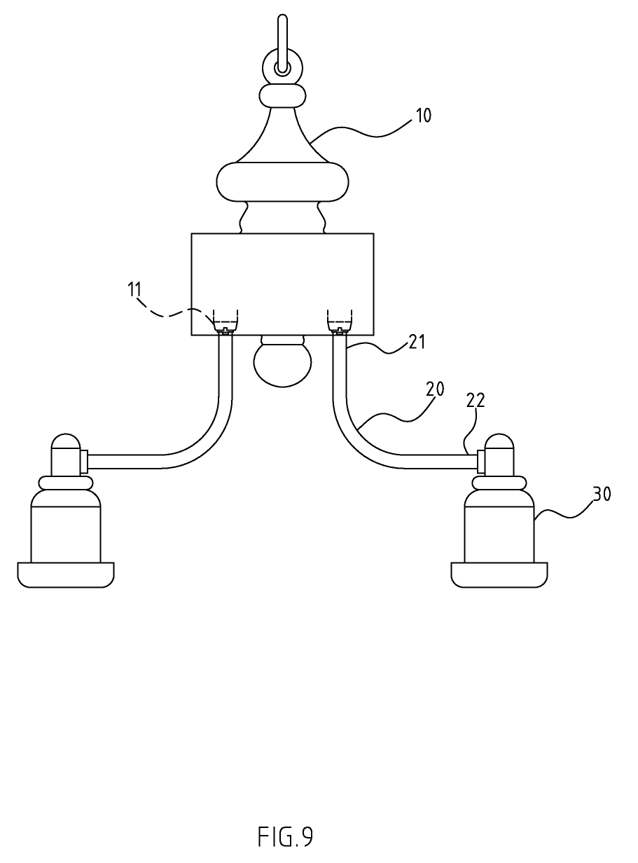

Additionally, referring to FIG. 9, the coupling portion 23 of connecting end 21 of said support 20 could be assembled on the lateral surface or top and bottom of the main pedestal 10.

1. A lamp comprising:
a main pedestal, having an assembly portion; and
a support, being provided with a connecting end corresponding to said main pedestal and a protruding end for assembly of a light-emitting body, said support being electrically connected to said main pedestal,
said connecting end being coupled with said main pedestal and provided with a coupling portion, said main pedestal being provided with a mounting portion for said coupling portion, said mounting portion having a positioning member to control positioning or a released state of said mounting portion and said coupling portion, said mounting portion and said coupling portion being fitted with an engageable electrical connector.

2. The lamp defined in claim 1, wherein said assembly portion of said main pedestal is a hanger or a free-standing rack.

3. The lamp defined in claim 1, wherein said coupling portion of said connecting end is assembled on a lateral surface or top and bottom of said main pedestal.

4. The lamp defined in claim 1, wherein said mounting portion of said main pedestal is a recessed hole, said connecting end of said support having a bar-like coupling portion set thereon, said positioning member being comprised of a locating hole on said coupling portion of a connecting end of said support, and flexible locking bead on said mounting portion of said main pedestal.

5. The lamp defined in claim 4, wherein said positioning member contains an external cylinder and an internal cylinder, said external cylinder having an inclined guide surface fitted externally onto said external cylinder, said internal cylinder being supported by an elastic member, said internal cylinder having a through-hole on a preset location corresponding to said coupling portion at said connecting end of said support, said external cylinder having a positioning bead placed between said through-hole and an inclined guide surface of said external cylinder, said positioning bead being pressed onto said coupling portion of said connecting end of said support, and being released by the internal cylinder.

6. The lamp defined in claim 1, wherein the electrical connector comprises a central conducting bar and a circular conducting strip on one end of said coupling portion, said central conducting bar being separated from said circular conducting strip via an insulator, said mounting portion having a central conducting terminal and an eccentric conducting terminal placed at intervals opposite to said mounting portion, said central conducting terminal contacting said central conducting bar of said coupling portion, said eccentric conducting terminal contacting said circular conducting strip of said coupling portion.
